(19) United States
(12) Patent Application Publication
(10) Pub. No.: US 2009/0046135 A1
(43) Pub. Date: Feb. 19, 2009

(54) Printer

(75) Inventors: Masahito Namai, Kanagawa (JP); Shigenori Nakata, Kanagawa (JP); Koji Enomoto, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/222,554

(22) Filed: Aug. 12, 2008

(30) Foreign Application Priority Data
Aug. 13, 2007 (JP) 2007-210731

(51) Int. Cl. B41J 2/01; H01J 61/40

(52) U.S. Cl. 347/102; 313/113

(57) ABSTRACT

In a printer, an image is formed by discharging a light curing type ink from a recording head on a recording medium and irradiating light from a light emission unit so as to harden the ink. The printer comprises a short arc type discharge lamp in which a pair of electrodes is provided in an electric discharge container so as to face each other a reflector which is provided so as to surround the discharge lamp, which has a concave face which reflect light from the discharge lamp wherein the pair of the electrodes are arranged so that a straight line formed by connecting the pair of electrodes, extends along an optical axis of the reflector, and wherein mercury of 0.08-0.30 mg/mm³, rare gas, and halogen is enclosed in the electric discharge container and a distance between electrodes is 0.5-2.0 mm.

### CROSS-REFERENCES TO RELATED APPLICATION

The disclosure of Japanese Patent Application No. 2007-210731, filed Aug. 13, 2007 including its specification, claims and drawings, is incorporated herein by reference in its entirety.

### TECHNICAL FIELD

Described herein is a printer which discharges a light curable ink to a recording medium, and then irradiates light to the ink thereby recording an image on the recording medium.

### BACKGROUND

Since a recording method called an ink jet printing can produce an image more simply and cheaply than a gravure printing method, in recent years, such an ink jet printing has been applied to various printing fields, such as special printings, that is, photograph, various printing method, marking, or color filters. In the ink jet recording method, a high quality image can be obtained by combining a printer for controlling discharge of a fine dot (ink), an ink whose color-reproduction range, durability, adequate accuracy of discharge, etc., is improved, and dedicated paper whose ink absorbency, color-material coloring nature, surface gloss, etc is dramatically improved. These printers can be classified according to kinds of inks. Among these printers, there is a light curing type ink jet system in which a light curing type ink hardened by light such as ultraviolet rays etc. is used. A light curing type ink jet system emits a comparatively low odor, and quick-drying capability can be chiefly expected even though the dedicated paper is not used. Moreover, it has been brought to attention since it is recordable on a recording medium without ink absorbency.

In such an light curing type inkjet printer (hereinafter referred to as a ink jet printer), in addition to the recording head (also referred to as an ink jet, below) from which a fine ink droplet is discharged to a recording medium, a light source which emits light is carried in a carriage of the printer. The carriage is moved while the light source is lit above the recording medium, and the light is irradiated to the ink immediately after the ink directly hits the recording medium, so that the ink is hardened (refer to, for example, Laid Open Patent Nos. 2005-246955, 2005-103852, and 2005-305742 and “The current situation and latest topics of the energy line hardened resin technology for paints,” NO. 11/2005, pp 1-20, DIC Technical Review of Dainippon Ink & Chemicals, Inc., Yoichi Abe). In addition, attempts have been made to use such an ink jet printer for not only record printing of such an image but also patterning of an electronic electrical circuit. In this case, the material in form of liquid which is discharged from an ink jet head is a material for circuit board formation, such as a light curing type resist ink. The base material to which printing (namely, formation of a pattern) is performed is a printed circuit board. In a formation of the circuit pattern with resist ink, drying and curing reaction by light, such as ultraviolet rays, is used as in the record printing of an image. Although there is difference therebetween, in that an ink material which is discharged from an ink jet head is a resist and an ink, the structure of the ink jet printer apparatus used for the patterning and printing is the same.

Description of an ink jet printer will be given below, as an example the apparatus which records an image on a base material using a light curable ink.

FIG. 8A is a schematic perspective view of a head section of an ink jet printer. FIG. 8B is a cross sectional view of light emitting units 6 or 7 shown in FIG. 8A, taken along a plane perpendicular to the optical axis of a lamp. In addition, FIG. 8A shows the light emitting units, wherein the interior thereof can be seen, so that explanation thereof becomes easy. The ink jet printer 1 has a rod shape guide rail 2, and a carriage 3 is supported by the guide rail 2. The carriage 3 performs back-and-forth movement along the guide rail 2 above the base material (recording medium) 5 by a carriage driving mechanism (not shown). The direction is referred to as a direction X, hereinafter. An ink jet head 4 in which a nozzle (not shown) for discharging an ink for each color for color printing is provided, is mounted in the carriage 3. The light emitting units 6 and 7 are provided in the both sides of the ink jet head 4 in moving directions of the carriage 3, and the light emitting units 6 and 7 irradiate ultraviolet rays to the ink which is the liquid material discharged onto the recording medium 5 from the nozzle of the ink jet head 4. In addition, a portion which consists of the ink jet head 4 and the light emitting sections 6 and 7 is referred to as a head section 1a below.

When printing is performed to the recording medium 5 while the carriage 3 moves toward the front side in the direction X of FIG. 8, ink from the ink jet head 4 of the head section la is hardened by the light from light emitting unit 6. Moreover, when printing is performed to the recording medium 5 while the carriage 3 moves toward the back side in the direction X of the figure, ink from the ink jet head 4 is hardened by light from the light emitting unit 7. As a light source which emits light (ultraviolet rays) of wavelengths required to harden the ink, for example, a high-pressure mercury lamp and a metal halide lamp, etc. each of which is a long arc type discharge lamp, are known. As shown in FIG. 8B, each of the light emitting units 6 and 7 has a box-like cover member 8 which has an opening 20, opening toward the recording-medium 5. A long arc type discharge lamp 90 is arranged, inside this cover member 8, along a direction (hereinafter referred to as a direction Y) perpendicular to the movement direction (the direction X) of the carriage 3. Each of the discharge lamp 90 is a linear light source, and the length of a light emission section thereof is approximately equal to the length (in the direction Y) of the ink jet head 4.

A gutter-like reflector 110 which reflects light (ultraviolet rays) emitted from the lamp 90, is provided in the opposite side of the opening 20 with respect to the lamp 90. As shown in FIG. 8B, the reflector 110 has an ellipse shape in a sectional view thereof, and the discharge lamp 90 is arranged at the first focal point of the reflector 110. Although the light (ultraviolet rays) emitted from the lamp 90 is condensed by the second focal point of the reflector 110 in a linear shape, direct light from the lamp 90 is also added thereto and is irradiated to the recording medium 5. The recording medium 5 is arranged so as to pass through a second focal point position of the reflector 110, or therenear, and the light condensed by the reflector 110 is irradiated onto the recording medium 5 to which the ink has reached.

As described above, as a light curable ink used for an ink jet printer, the ultraviolet curing type ink which is hardened by so-called ultraviolet rays, is used. And as a light source which emits the ultraviolet rays, as described above, the high-pressure mercury lamp or the metal halide lamp in which heavy metal is enclosed in addition to mercury, is used. Reaction of polymerization initiator contained in the ink is started by ultraviolet-rays irradiation, and the ultraviolet curing type ink is hardened. A radical curing type initiator is often used as such a polymerization initiator, and it is known that wavelengths of the light to be absorbed (that is, polymerization is started) is 250-400 nanometers (nm) (refer to, for example, “The current situation and latest topics of the energy line hardened resin technology for paints,” NO. 11/2005, page 1, column 2, lines 12 to page 2, column 1, line 5, DIC Technical Review of Dainippon Ink & Chemicals, Inc.). Therefore, it is desirable that, as a light source of the ink jet printer, many components of light with wavelengths of 250-400 nm be contained in the light emitted.

On the other hand, an ink jet printer is often used for a large-sized graphic printing of car exterior display, outside/indoor ornament display etc. Therefore, as a recording medium, i.e., a base material to be printed, an acrylics film which is excellent in weather resistance, is often used for the car exterior or outside display. In addition, a PET (polyethylene terephthalate) film which is excellent in transparency, thermal resistance, electric insulation, and chemical resistance, is also often used for indoor ornament display. Moreover, in addition to this, polycarbonate (used for a digital video disc), ABS resin, polystyrene (PS), etc. are used as a base material. Each of the base materials of macromolecule (pi conjugation polymer) having, for example, a pi covalent bond, such as PET, a polycarbonate, ABS resin, and PS, has an absorption band at approximately 200 nm-300 nm. Moreover, although acrylics is not pi conjugation polymer, the penetration threshold wavelength thereof in an ultraviolet range is 280 nm, and light of the wavelength which is not greater than that, is absorbed therein. Therefore, when the base material absorbs light with a wavelength of 300 nm or less, so that the absorbed light energy is changed into heat, the temperature of the base material may go up and, as a result, deformation thereof may occur. Therefore, it is desirable that light with wavelengths of 300 nm or less which such a base material absorbs, is not contained in the light emitted from the light source.

However, in light emitted from the high-pressure mercury lamp or the metal halide lamp, which is conventionally used, not only light with wavelengths of 300-400 nm but light with wavelengths of 300 nm or less is also contained. Therefore, if, in order to shorten curing time of ink, the irradiance of light with wavelengths of 300-400 nm is increased by increasing electric power of the lamp, the irradiance of the light of the wavelengths of 300 nm or less is also increased. Therefore, the base material is heated so that there is a problem that deformation tends to occur.

Insertion of a wavelength cut-off filter is known as a method of removing light of a certain wavelength band from light emitted from a lamp. A multilayer film deposition filter is known as a filter which cuts a short wavelength. A multilayer film deposition filter is formed in form of a multilayer consisting of inorganic films whose thickness is adjusted according to wavelengths to be cut. However, since the high-pressure mercury lamp or the metal halide lamp which is conventionally used as a light source is a long arc type lamp, diverging light is emitted from the long arc type lamp. Therefore, even if the multilayer film deposition filter which cuts short wavelength between the lamp and the base material is provided, the light enters the filter at various angles, so that the film thickness of the multilayer film which is formed in the filter seemingly changes depending on incident angles of the light. Therefore, All the light with wavelengths of 300 nm or less cannot be cut.

### SUMMARY

In view of the above, described herein is a printer in which a light curable ink is discharged toward a recording medium from a recording head, and in which the ink on the recording medium is hardened by emitting light from a light emitting unit, thereby recording an image thereon, wherein a lamp in which although many components of light with wavelengths of 300-400 nm are contained in light from the light source but light with wavelengths of 300 nm or less is not contained therein, is used, so as not to heat the base material even if electric power of the lamp is increased, and not to cause deformation thereof.

As mentioned above, in an ink jet printer which uses light curable ink, it is desirable that the light emitted from the light source does not contain light with wavelengths of 300 nm or less which a base material absorbs.

As a result of examining various matters, it found out that it is suitable that a short arc type ultra-high pressure mercury lamp whose distance between electrodes is 0.5-2.0 mm, is used as a discharge lamp for the light source, in which a pair of electrodes is arranged in an electric discharge container so as to face each other, and mercury of 0.08-0.30 mg/mm³, rare gas, and halogens is enclosed in an electric discharge container. In the case of the high-pressure mercury lamp or the metal halide lamp which is used as a light source of a conventional ink jet printer, although a component of the wavelengths of the range of 300-400 nm are contained in light emitted from a lamp, a component of the wavelengths of 300 nm or less is also contained. On the other hand, although the component of the wavelengths of the range of 300-400 nm is contained in light emitted from the ultra-high pressure mercury lamp according to the present invention, most of the component of wavelengths of 300 nm or less is not contained.

In addition, although the ultra-high pressure mercury lamp is known as a lamp used for a projector, since attention is not paid to the spectral distribution of the wavelength range of 300 nm or less, there is no recognition that it is suitable to use it as a light source for an ink jet printer.

The present ultra-high pressure mercury lamp is used as a light source, in which a concave reflector arranged so as to surround a lamp is provided, and a straight line connecting a pair of electrodes of the lamp extends along the optical axis of the reflector.

The optical axis of the reflector is, for example, the same as an axis of the rotation symmetry. The present reflector may have at least 180 degrees rotation symmetry (two fold symmetry), and ellipsoid of revolution or paraboloid of revolution is often used therefor.

In such a structure, only a component of light reflected on the reflector among components of the light from the lamp is emitted, and the direct light from the lamp is hardly emitted. For this reason, if a multilayer film deposition mirror which reflects only ultraviolet rays is used as a reflector, even if the light of a visible region to an infrared region is contained in the light emitted from a lamp, such light is not directly irradiated onto a base material (recording medium). Moreover, it is possible to prevent the radiant heat generated by lighting of the discharge lamp from being directly irradiated onto the base material (recording medium), so that a degree of the influence of the heat to the base material (recording medium) can be reduced.

In view of the above, in order to solve the problems, in the present printer, an image is formed by discharging a light curing type ink from a recording head on a recording medium and irradiating light from a light emission unit so as to harden the ink. The printer comprises a short arc type discharge lamp in which a pair of electrodes is provided in an electric discharge container so as to face each other, a reflector which is provided so as to surround the discharge lamp, which has a concave face which reflect light from the discharge lamp, wherein the pair of the electrodes are arranged so that a straight line formed by connecting the pair of electrodes, extends along an optical axis of the reflector, and wherein mercury of 0.08-0.30 mg/mm³, rare gas, and halogen is enclosed in the electric discharge container and a distance between electrodes is 0.5-2.0 mm. The optical axis may be

The printer may include a mirror which forms light reflected by the reflector so as to be in a linear shape, wherein the discharge lamp is arranged so that the straight line formed by connecting the pair of electrodes to be perpendicular to the recording medium.

Also, the printer may include a first mirror which changes a direction of light reflected by the reflector and a second mirror which forms light directed by the first mirror so as to be in a linear shape, wherein the discharge lamp is arranged so that the straight line formed by connecting the pair of electrodes to be parallel to the recording medium.

Accordingly, effects set forth below can be acquired.

(1) Since the short arc type ultra-high pressure mercury lamp in which mercury of 0.08-0.30 mg/mm³, rare gas, and halogen gas is enclosed in the electric discharge container and the distance between electrodes is 0.5-2.0 mm, is used as a light source for the ink jet printer, light with wavelengths of 300 nm or less is hardly emitted, and deformation due to heating of the base material can be prevented.

(2) Since the concave reflector which reflects light from the discharge lamp and is arranged so that the discharge lamp may be surrounded, is provided and a straight line connecting a pair of electrodes of the lamp may extend along the optical axis of the reflector, among components of light from the discharge lamp, the light emitting unit emits only light reflected by the reflector, so that direct light from the lamp is hardly emitted. For this reason, by using the mirror which reflects only ultraviolet rays as the reflector, even if the radiant heat and the light in a range from a visible region to an infrared region, from the lamp is emitted, it is possible to prevent the base material (recording medium) from being irradiated directly, so that the degree of the influence of heat to the base material (recording medium) can be reduced further.

### BRIEF DESCRIPTION OF THE DRAWINGS

Other features and advantages of the present printer will be apparent from the ensuing description, taken in conjunction with the accompanying drawings, in which:

FIG. 1 is a schematic cross sectional view of the structure of an ink jet printer according to a first embodiment;

FIG. 2 is a graph showing the radiant efficiency of wavelength band of an ultra-high pressure mercury lamp according to an embodiment, that of high-pressure mercury lamp, and that of a metal halide lamp of prior art;

FIG. 3 is a graph showing a Deep UV ratio of an ultra-high pressure mercury lamp according to an embodiment, that of a high-pressure mercury lamp, and that of a metal halide lamp of prior art;

FIG. 4 is graph showing a spectral distribution of a range of 250 nm-450 nm wavelength of an extra-high pressure mercury lamp according to an embodiment;

FIG. 5 is a graph showing a spectral distribution of a range of 250 nm-450 nm wavelengths of a high-pressure mercury lamp of prior art;

FIG. 6 is a graph showing a spectral distribution of a range of 250 nm-450 nm wavelengths of a metal halide lamp of prior art;

FIG. 7 is a schematic cross sectional view of the structure of an ink jet printer according to a second embodiment;

FIG. 8A is a schematic view of the structure of a head section of a conventional ink jet printer; and

FIG. 8B is a cross sectional view of a conventional light emitting unit.

### DESCRIPTION

The descriptions in the specification are provided for illustrative purposes only, and are not limiting thereto. An appreciation of various aspects of the present printer is best gained through a discussion of various examples thereof. The meaning of these terms will be apparent to persons skilled in the relevant arts based on the entirety of the teachings provided herein.

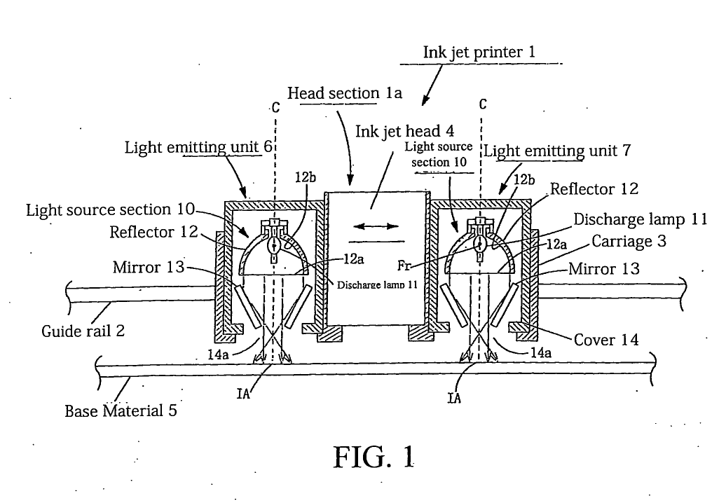

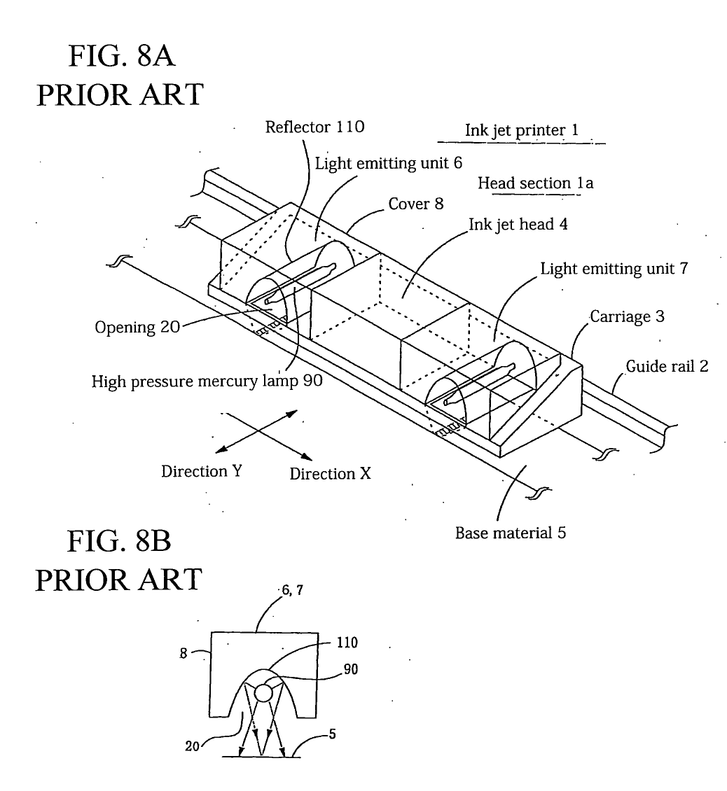

FIG. 1 shows a first embodiment according to the present invention. FIG. 1 is a schematic cross sectional view showing the structure of a head section of an ink jet portion, in which light emitting units, each of which is equipped with an ultra-high pressure mercury lamp, are provided to the head section of the ink jet printer. In addition, although description of the ink jet printer which is used for an image printing will be given below as an example, it can be similarly applied to a formation of patterns of, for example, a circuit. The ink jet printer according to this embodiment has, for example, the same structure as that shown in FIGS. 8A and 8B, except that the structure of the light emitting units is different from those shown in FIG. 8. Namely, the ink jet printer 1 includes the head section 1a including an ink jet head 4 and the two light emitting units 6 and 7, and the head section is supported by a carriage 3. In the ink jet head 4, a nozzle (not shown) which discharges fine droplets of a light curable ink, for example, a material in form of liquid, such as an ultraviolet curing type ink, to a base material 5 is provided. The two light emitting units 6 and 7 are provided in the both sides of this ink jet head 4, and harden an ink which reaches the base material 5, by irradiating light of a predetermined wavelength band, for example, ultraviolet rays.

The head section la is supported by the cylindrical guide rail 2 provided so as to extend along the base material 5. A driving mechanism (not shown) enables both-way movements in the horizontal directions of the figure, above the base material 5 along with the guide rail 2. For example, a radical polymerization system ink which contains a radical-polymerizable compound as a polymerizable compound, or a cationic polymerization system ink which contains a cationic polymerizable compound as a polymerizable compound may be used as an ultraviolet curing type ink. In addition, when such an ink jet printer is used for pattern formation of, for example, a circuit, a resist ink containing a light intensity synthetic compound etc. is used as a material in form of liquid which is discharged from the ink jet head. For example, paper, resin, a film, a printed circuit board, etc. can be used as the base material 5. As the resin, PET (polyethylene terephthalate), ABS, acrylic resin, etc. may be used.

Next, the structure of the light emitting units 6 and 7 is explained. Each of the light emitting unit is equipped with the ultra-high pressure mercury lamp 11 which is a short arc type discharge lamp, and a light source section 10 which comprises a reflector 12 for reflecting light from the discharge lamp, wherein light from the discharge lamp 11 is irradiated so that an light emitting area extending in a linear shape may be formed on a light exposed face. Each of the light emitting units 6 and 7 has, for example, an exterior cover 14 having a box shape as a whole, and a light emitting window 14a which is open (in the base material 5 side) at a lower part of FIG. 1. The light source section 10 having the ultra-high pressure mercury lamp 11, and the reflector 12 which is arranged so as to surround the lamp 11 and which reflects light emitted from the lamp 11, is provided in the exterior cover 14. Moreover, reflective mirrors 13 for emitting light to the outside through the light emitting window 14a are arranged, so that the light from the light source section 10 is shaped so as to extend in a linear shape on a light emitting area. The reflector 12 which forms the light source section 10 is formed as a parabola mirror which has a reflective surface 12b in a shape of revolution paraboloid whose center is an optical axis C. A light emitting opening 12a of the reflector 12 faces the light emitting window 14a of the light emitting unit 10, and opens downward (in the base material 5 side) in FIG. 1. The optical axis C is arranged so as to be perpendicular to the light exposed face (material face).

While a pair of electrodes is arranged in an electric discharge container of the ultra-high pressure mercury lamp 11 which forms the light source section 10, in a state where the distance between the electrodes is set to 0.5-2.0 mm, a predetermined amount of mercury which is a light-emitting material, and a predetermined amount of rare gas and halogen which are buffer gas for start-up assistance are enclosed. Here, the enclosure amount of the mercury is 0.08-0.30 mg/mm³. In a state where the light emission section (radiant spot of an arc) is located in a focal point Fr of the reflector 12, the lamp 11 is arranged so that a straight line connecting a pair of electrodes may extend along the optical axis C of the reflector 12. Each of mirrors 13 has the shape of a long and slender plane, and is arranged so that the longitudinal direction thereof may extend in the direction of the front and back side of FIG. 1. The two mirrors 13 are arranged to face each other, and to form the long and slit-like light emitting window 14a in the front/back directions of FIG. 1. The light from the lamp 11 becomes parallel light along the optical axis C, when the light is reflected by the reflector 12 which has the revolution paraboloid reflective surface 12b, and part of the light is directly emitted from light emitting window 14a. The other parts of the light is reflected by the mirrors 13 and is emitted from the light emitting window 14a. On the base material 5, a long and narrow light emitting area IA extending in the front/back directions of FIG. 1 is formed.

Here, in the discharge lamp 11, the straight line formed by connecting the pair of electrodes is located along the optical axis C of the reflector 12. The electrodes are provided at a portion where the opening of the reflector 12 of the discharge lamp 11 faces. For this reason, light which is emitted from the discharge lamp 11 is not directly irradiated to the light exposed face (material face), so that most of the light emitted from the discharge lamp 11 becomes parallel light when it is reflected on the reflector 12. When as the reflector 12, a deposition mirror which reflects light with short wavelength, but transmits light with long wavelengths in a range of a visible region to an infrared region which does not contribute curing of the ink is provided, even if the light with wavelengths of 300 nanometers (nm) or less is emitted from the ultra-high pressure mercury lamp 11, it is possible to prevent light which is unnecessary for hardening the ink, from being irradiated onto the base material 5, so that it is possible to prevent the base material 5 from being heated. Furthermore, if a filter which cuts the light with the wavelengths of 300 nm or less is inserted into a light emitting side of the light source section 10, it is possible to further prevent the light with wavelengths of 300 nm or less from being irradiated onto the base material 5.

In the ink jet printer, when the head section 1a equipped with the ink jet head 4 and the light emitting units 6 and 7, moves above the base material 5 in the state where the ultra-high pressure mercury lamp 11 is lit, the light from the lamp 11 is formed on the base material 5 so as to be a linear light emitting area extending in a direction (perpendicular to the face of FIG. 1) which is orthogonal to the direction of movement of the head section 1a, so that the ultraviolet curing type ink is immediately hardened after reaching the base material 5. The curing processing of the ultraviolet curing type ink is explained in detail, below. In FIG. 1, when printing is performed to the base material 5 while the head section 1a is moved rightward, the ultraviolet curing type ink which reaches the base material 5 is hardened by the light irradiated from the light emitting unit 6 located in a back side of the head section 6 in the movement direction thereof. On the other hand, when printing is performed to the base material 5 while the head section 1a is moved leftward in FIG. 1, the ultraviolet curing type ink which reaches the base material 5 is hardened by the light irradiated from the light emitting unit 7 located in a back side of the head section 6 in the movement direction thereof.

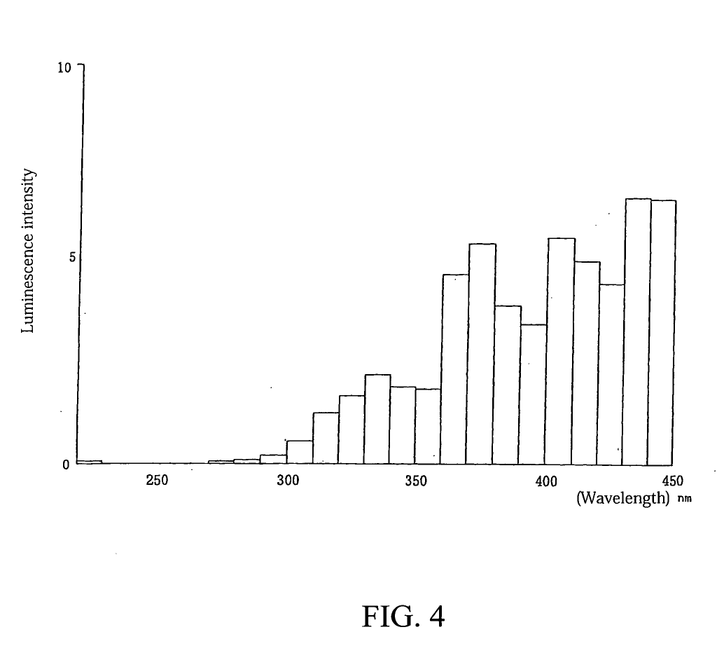

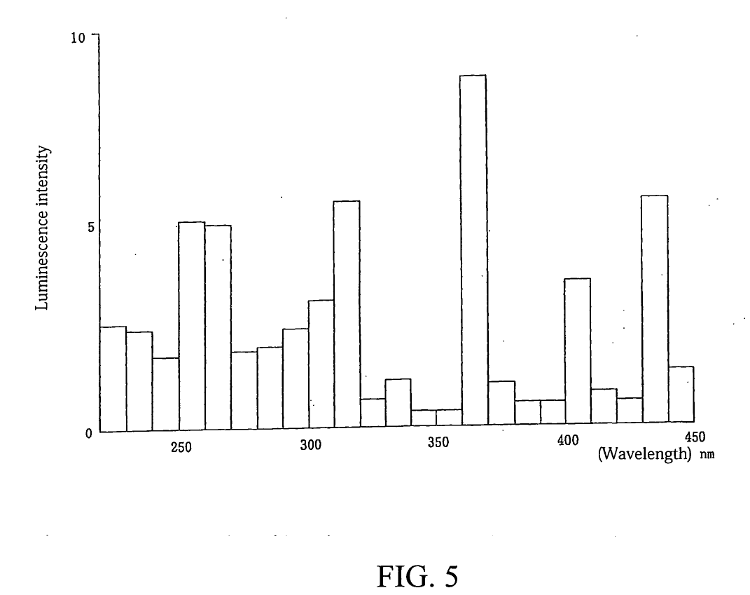

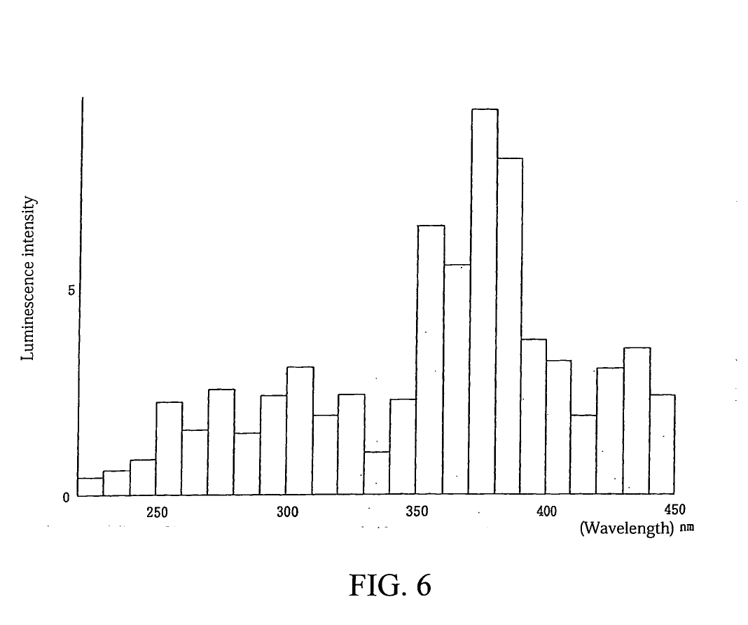

Here, the property of the ultra-high pressure mercury lamp used in the above embodiments, and that of the high-pressure mercury lamp and the metal halide lamp used in the prior art are compared with each other below. FIGS. 4-6 show the spectral distribution of a wavelength range of 250 nm-450 nm of the ultra-high pressure mercury lamp according to the embodiments, that of the high-pressure mercury lamp and that of the metal halide lamp of the prior art, respectively. In these figures, a horizontal axis shows wavelength (nm) and a vertical axis shows luminescence intensity (relative value). As shown in FIGS. 5 and 6, in a case of the high-pressure mercury lamp or the metal halide lamp which is used as a light source of the conventional ink jet printer, although the component of the wavelength range of 300-400 nm is contained in light emitted from a lamp, a component of 300 nm or less is also contained therein. However, as shown in FIG. 4, although the component of the wavelength range of 300-400 nm is contained in light emitted from the ultra-high pressure mercury lamp according to the embodiment, most of the component of 300 nm or less is not contained therein.

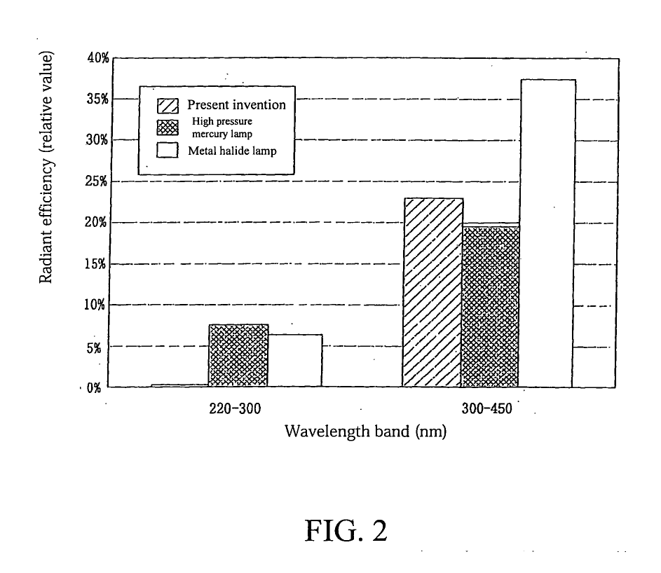

The radiant efficiency of a wavelength band of the ultra-high pressure mercury lamp according to the embodiments, that of the high-pressure mercury lamp of prior art, and that of a metal halide lamp are shown in FIG. 2. FIG. 2 shows what percent of the full wavelength area of light emitted from the lamp, a component of light in a range of 220 nm-300 nm wavelengths and that in a range of 300 nm-450 nm wavelengths make, when the same input electric power is applied to each lamp, based on the spectral distribution shown in FIGS. 4-6. In addition, the amount of mercury in the high-pressure mercury lamp is 0.03 mg/mm³, and the amount of mercury in the metal halide lamp is 1.7×10⁻⁴ mg/mm³. Although, as shown in this figure, the light in the range of 300 nm-450 nm wavelengths emitted from the metal halide lamp is the most among these lamps, the light in the range of 220 nm-300 nm wavelengths is also emitted. On the other hand, even though the ultra-high pressure mercury lamp according to the embodiments hardly emits the light in the range of 220 nm-300 nm wavelengths, the light in the range of 300 nm-450 nm wavelengths is emitted more than that from the high-pressure mercury lamp.

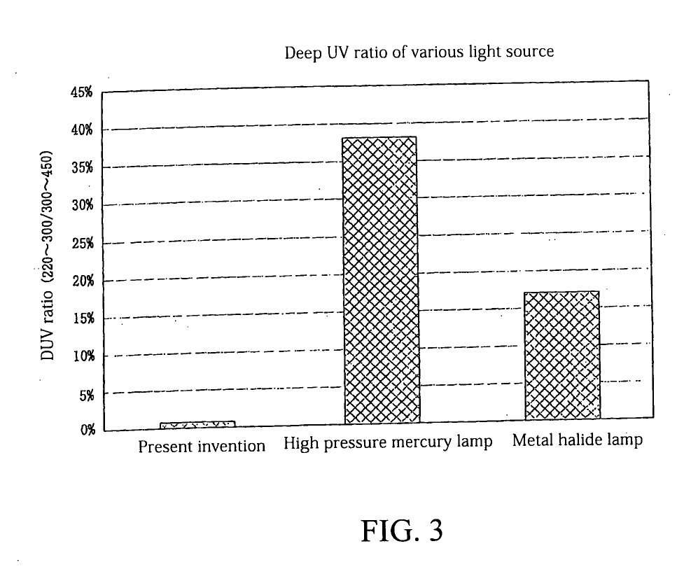

FIG. 3 shows a result (Deep UV ratio) which was obtained by dividing a value of the wavelengths of 220 nm-300 nm by a value of the wavelengths of 300 nm-450 nm, in an embodiment shown in FIG. 1. This value represents the amount of the light with the wavelengths of 220 nm-300 nm in case where the amount of light with wavelengths of 300 nm-450 nm was the same in the lamps which were compared with one another. As shown in this figure, in the ultra-high pressure mercury lamp according to the embodiments, there was almost no light intensity with the wavelength of 220 nm-300 nm, compared with the amount of light with the wavelengths of 300 nm-450 nm. Therefore, even if an irradiance with the wavelength of 300 nm-450 nm was increased by increasing electric power of the lamp in order to shorten the processing time for curing ink by light, since there was little light with the wavelengths of 300 nm or less emitted from the lamp, the base material did not absorb light with wavelengths of 300 nm or less so that the base material was not heated, whereby it was possible to prevent the problem of deformation etc.

Although, in the first embodiment shown in FIG. 1, the straight line connecting the pair of electrodes of the discharge lamp 11 is perpendicular to the base material (recording medium) 5, in a second embodiment which is described below, a straight line connecting a pair of electrodes of a discharge lamp 11 is parallel to the base material (recording medium).

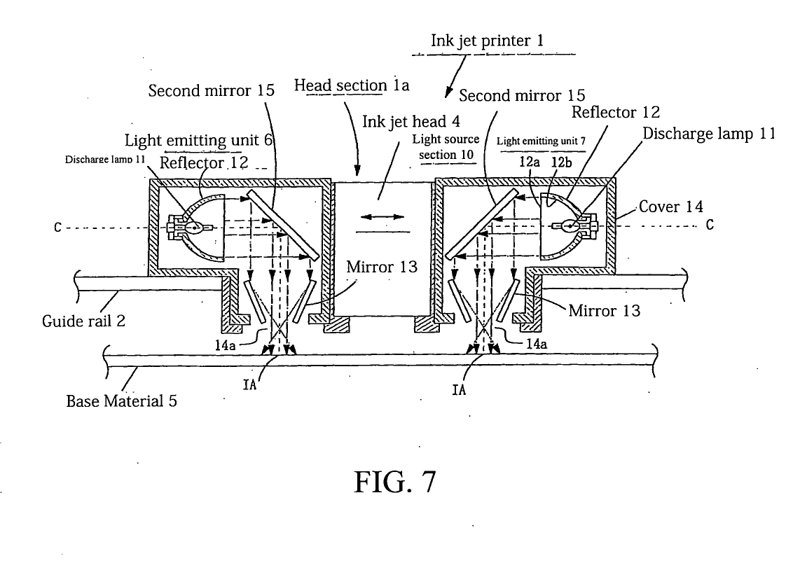

FIG. 7 shows a second embodiment. FIG. 7 is a schematic cross sectional view of the structure of a head section of an ink jet printer having light emitting units. The ink jet printer according to this embodiment has the same structure as that shown in FIG. 1, except that the structure of the light emitting units is different from that shown in FIG. 1. The ink jet printer 1 includes an ink jet head 4 and the two light emitting units 6 and 7 which are provided in the both sides of this ink jet head 4. The ink jet head 4 and the two light emitting units 6 and 7 are supported by the head section 1a, and the head section 1a is carried by a carriage 3.

Each of the light emitting units 6 and 7 is equipped with an ultra-high pressure mercury lamp 11 which is a short arc type discharge lamp, and a light source section 10 comprising a reflector 12 which reflects light from the discharge lamp as in the first embodiment, in which light from the discharge lamp 11 is irradiated so that the light emitting area extending in a linear shape is formed on a light exposed face. The light source section 10 having the ultra-high pressure mercury lamp 11, and the reflector 12 which is arranged so as to surround the lamp 11 and which reflects light emitted from the lamp 11, is arranged inside the exterior cover 14 of each light emitting unit (6 and 7). The reflector 12 is formed as a parabola mirror which has a reflective surface 12b in a shape of revolution paraboloid whose center is an optical axis C. Moreover, as shown in FIG. 7, when the discharge lamp 11 is horizontally arranged, a second mirror 15 which reflects light reflected by the reflector 12 is arranged at the incidence side of a mirror 13 which forms a light emitting window 14a.

While in an electric discharge container of the ultra-high pressure mercury lamp 11, as mentioned above, a pair of electrodes is arranged so as to face each other at an interval (a distance between electrodes) of 0.5-2.0 mm, a predetermined amount of mercury which is a light-emitting material, and a predetermined amount of rare gas and halogen which are buffer gas for start-up assistance are enclosed. For example, the enclosure amount of the mercury is 0.08-0.30 mg/mm³. As mentioned above, in a state where the light emission section (luminescent spot of an arc) is located at the focal point Fr of the reflector 12, the lamp 12 is arranged so that a straight line connecting a pair of electrodes may extend along the optical axis C of the reflector 13. These two mirrors 13 are arranged to face each other, and to form a long and slit-like light emitting window 14a in the front/back directions of FIG. 7. The light from the lamp 11 becomes parallel light to the optical axis C when the light is reflected by the reflector 12 which has the revolution paraboloid reflective surface 12b, and then part of the light is directly emitted from light emitting window 14a. The other parts of the light is reflected by the mirror 13 and is emitted from the light emitting window 14a. On the base material 5, a long and narrow light emitting area IA extending in the front/back directions of FIG. 7 is formed.

Also in this embodiment, in the discharge lamp 11, the straight line formed by connecting the pair of electrodes is located along the optical axis C of the reflector 12. The electrodes are provided so as to face the opening of the reflector 12 of the discharge lamp 11. For this reason, light which is emitted from the discharge lamp 11 is not directly irradiated to the light exposed face (material face), so that most of the light emitted from the discharge lamp 11 becomes parallel light when it is reflected on the reflector 12. Therefore, when as the reflector 12, a deposition mirror which reflects light with short wavelength, but transmits light with long wavelengths in a range of a visible region to an infrared region which does not contribute the curing of the ink, is provided, it is possible to prevent light unnecessary for curing the ink, from being irradiated onto the base material 5. Furthermore, if a filter which cuts light with a wavelength of 300 nm or less is inserted in the light emitting side of the light source section 10, it is possible to prevent the light with wavelengths of 300 nanometers (nm) or less from being irradiated on the base material 5.

In the ink jet printer, as described above, when the head section 1a equipped with the ink jet head 4 and the light emitting units 6 and 7, moves above the base material 5 in the state where the ultra-high pressure mercury lamp 11 is lit, the light from a lamp 11 is formed on the base material 5 so as to be a linear light emitting area extending in a direction (perpendicular to the face of FIG. 7) which is orthogonal to the direction of movement of the head section 1a, so that the ultraviolet curing type ink is immediately hardened after reaching the base material 5. As mentioned above, since the component of light with the wavelength of 300 nm or less is hardly contained in the light emitted from the ultra-high pressure mercury lamp, even if the base material is one that is deformed when it is heated by absorbing light with the wavelength of 300 nm or less, it is possible to perform printing or formation of a circuit pattern while preventing deformation of the base material. In addition, since an ultra-high pressure mercury lamp is a short arc discharge lamp so that its is high, light with a high peak irradiance can be irradiated to the ultraviolet curing type ink which has reached the base material 5, whereby the ultraviolet curing type ink is promptly hardened (photo polymerization) after reaching the base material 5, so that it is possible to shorten the curing time. Therefore, it is possible to prevent deterioration of a dot shape with age, so that it is possible to certainly form an image with high quality or patterns of a circuit.

The preceding description has been presented only to illustrate and describe exemplary embodiments of the present printer. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A printer with which an image is formed by discharging a light curing type ink from a recording head on a recording medium and irradiating light from a light emission unit so as to harden the ink, comprising:
a short arc type discharge lamp in which a pair of electrodes is provided in an electric discharge container so as to face each other;
a reflector which is provided so as to surround the discharge lamp, which has a concave face which reflect light from the discharge lamp;
wherein the pair of the electrodes are arranged so that a straight line formed by connecting the pair of electrodes, extends along an optical axis of the reflector, and
wherein mercury of 0.08-0.30 mg/mm³, rare gas, and halogen is enclosed in the electric discharge container and a distance between electrodes is 0.5-2.0 mm.

2. The printer according to claim 1, further including a mirror which forms light reflected by the reflector so as to be in a linear shape, wherein the discharge lamp is arranged so that the straight line formed by connecting the pair of electrodes to be perpendicular to the recording medium.

3. The printer according to claim 1, further including a first mirror which changes a direction of light reflected by the reflector and a second mirror which forms light directed by the first mirror so as to be in a linear shape, wherein the discharge lamp is arranged so that the straight line formed by connecting the pair of electrodes to be parallel to the recording medium.

4. The printer according to claim 1, wherein the reflector is a deposition mirror which reflects light with short wavelengths, but transmits light with long wavelengths in a range of a visible region to an infrared region which does not contribute curing of the ink.

5. The printer according to claim 1, wherein the light emitting unit include a first light emitting unit and a second light emitting unit.

6. The printer according to claim 5, wherein the first and second light emitting units are provided in both sides of the recording head in moving directions thereof.

7. The printer according to claim 6, wherein the recording head is moved first and second directions.

8. The printer according to claim 7, wherein when printing is performed to the recording medium while the recording head moves toward the first direction, ink from the recording head 4 is hardened by light from the first light emitting unit, and when printing is performed to the recording medium while the recording head moves toward the second direction, ink from the recording head is hardened by light from the second light emitting unit.

9. The printer according to claim 1, wherein the reflector is a parabola mirror which has a reflective surface in a shape of revolution paraboloid whose center is an optical axis of the reflector.

10. The printer according to claim 1, further including a carriage on which the recording head and the light emitting unit are provided.

11. The printer according to claim 1, wherein the recording head has a nozzle which discharges a ink droplet onto the recording medium.
